(19) United States
(12) Patent Application Publication
(10) Pub. No.: US 2013/0252200 A1
(43) Pub. Date: Sep. 26, 2013

(54) PLASTER TEETH MODEL GRIPPER AND ARTICULATOR HAVING THE SAME

(71) Applicant: Jae-Soo UM, Seoul (KR)

(72) Inventor: Jae-Soo UM, Seoul (KR)

(21) Appl. No.: 13/474,522

(22) Filed: May 17, 2012

(30) Foreign Application Priority Data
Mar. 26, 2012 (KR) 10-2012-0030544

(51) Int. Cl. A61C 11/08

(52) U.S. Cl. 433/60

(57) ABSTRACT

A plaster teeth model gripper and an articulator having the same that is capable of allowing a desired tooth to be attached to and detached from a plaster teeth model through only the cutting of a plaster teeth model, being simply manufactured, and being easily mounted on an articulator. The plaster teeth model gripper includes: a base plate disposed in a flat form on the underside of a gum of a teeth model; and a teeth model gum-supporting frame formed erectly on one surface of the base plate along the outer periphery of the gum of the teeth model in such a manner as to form a teeth model gum chamber open in a vertical direction from the base plate at the inside thereof.

### CROSS REFERENCES

Applicant claims foreign priority under Paris Convention to Korean Patent Application No. 10-2012-0030544 filed Mar. 26, 2012, with the Korean Intellectual Property Office, where the entire contents are incorporated herein by reference.

### BACKGROUND OF THE INVENTION

1. Field of the Invention

The present invention relates to a plaster teeth model gripper and an articulator having the same, and more particularly, to a plaster teeth model gripper that is capable of allowing a desired tooth to be attached to and detached from a plaster teeth model through only the cutting of a plaster teeth model, being simply manufactured, and being easily mounted on an articulator, and an articulator having the plaster teeth model gripper.

2. Background of the Related Art

Typically, an articulator used in dentistry is a mechanical device used to fix a plaster teeth model for manufacturing denture thereto, thereby helping a dental technician manufacture the denture.

A conventional articulator has an arm having one end rotatably disposed at an upper end of a column erected from one end of a base and plaster models being solidified are fixedly disposed at the arm and the base, thereby performing the articulation of the plaster models. Alternatively, the conventional articulator has upper and lower fixing means having upper and lower grippers manipulated by means of fastening bolts to fix upper and lower teeth models to the arm and the base.

According to the conventional articulator using plaster, however, when a plaster teeth model is detached after manufacturing denture is finished, there occur some problems that the plaster teeth model may be broken by means of strokes, the articulator may be also damaged, the environmental pollution may be caused by plaster waste, and the time for solidifying the plaster is much needed to make the workability deteriorated, and the cost of plaster material may be increased. On the other hand, according to the conventional articulator using the upper and lower grippers for mechanically fixing the upper and lower teeth models, the fixing is carried out by means of the fastening bolts, and in the process where the articulation is repeatedly carried out many times, the fastening force becomes weakened to change the articulation posture, thereby causing defects in the articulation.

So as to solve the above-mentioned problems, therefore, there has been proposed Korean Patent No.10-0601345 entitled ‘dental articulator having dual balls’, which is capable of finely adjusting a three-dimensional articulation posture and exerting a secure fastening force by a lever, but in this case, since three fastening bolts are provided, it is hard to perform accurate fixing and manipulation of the fastening bolts.

### SUMMARY OF THE INVENTION

Accordingly, the present invention has been made in view of the above-mentioned problems occurring in the prior art, and it is an object of the present invention to provide a plaster teeth model gripper and an articulator having the same that is capable of allowing a desired tooth to be attached to and detached from a plaster teeth model through only the cutting of a plaster teeth model, thereby avoiding the inconvenience in manufacturing double or triple plaster dies using separate metal pins and the unnecessary consumption of the materials used, and that is capable of simply manufacturing the plaster teeth model, and that is capable of being easily mounted on the articulator.

To accomplish the above object, according to an aspect of the present invention, there is provided a plaster teeth model gripper including: a base plate disposed in a flat form on the underside of a gum of a teeth model; and a teeth model gum-supporting frame formed erectedly on one surface of the base plate along the outer periphery of the gum of the teeth model in such a manner as to form a teeth model gum chamber open in a vertical direction from the base plate at the inside thereof.

According to the present invention, desirably, the teeth model gum-supporting frame has a plurality of equally spaced-apart protrusions formed in the height direction along the inner periphery thereof.

According to the present invention, desirably, the plurality of equally spaced-apart protrusions is gradually increased in sectional areas in the height direction.

According to the present invention, desirably, the teeth model gum chamber has a base protrusion formed from the bottom surface of the base plate at the inside thereof.

According to the present invention, desirably, the base protrusion has a shape of a continuously bent plate.

According to the present invention, desirably, the base plate has a circular steel plate attached on the underside thereof.

According to the present invention, desirably, the teeth model gum-supporting frame has a shape of a partial or full mouth.

According to the present invention, desirably, a plaster teeth model is mounted in the teeth model gum chamber.

To accomplish the above object, according to another aspect of the present invention, there is provided an articulator having a lower plate on which a lower side teeth model is mounted, an arm having one end rotatably disposed at a column erected from one side of the lower plate, and an upper plate on which an upper side teeth model is mounted in such a manner as to be supported on the other end of the arm, wherein a plaster teeth model gripper is mounted on the upper plate and the lower plate, respectively, the plaster teeth model gripper having a base plate disposed in a flat form on the underside of a gum of a teeth model and a teeth model gum-supporting frame formed erectedly on one surface of the base plate along the outer periphery of the gum of the teeth model in such a manner as to form a teeth model gum chamber open in a vertical direction from the base plate at the inside thereof.

According to the present invention, desirably, the upper plate and the arm have balls mounted on the top surface thereof and the end portion thereof, and the balls are connected to each other through the spherical coupling with a pair of ball clamps by means of a clamp bolt having left-handed and right-handed screws provided around the center of the ball clamps so as to fasten the pair of ball clamps facing each other.

According to the present invention, desirably, the articulator further has a magnet disposed on the underside of the upper plate and the top of the lower plate, respectively, so as to attach the plaster teeth model gripper thereto through a magnetic force generated therefrom.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an articulator having a plaster teeth model gripper disposed thereon according to the present invention;

FIG. 2 is a side view of FIG. 1;

FIG. 3a is a perspective view showing a plaster teeth model gripper according to a first embodiment of the present invention;

FIG. 3b is a plan view of FIG. 3a;

FIG. 3c is a perspective view showing an example wherein a plaster teeth model is molded in the gripper of FIG. 3a; and

FIGS. 4a and 4b are plan views showing medium and large-sized plaster teeth model grippers according to second and third embodiments of the present invention; and

FIG. 5 is an enlarged view showing the main parts of FIG. 3a.

### DETAILED DESCRIPTION OF THE PREFERRED EMBODIMENT

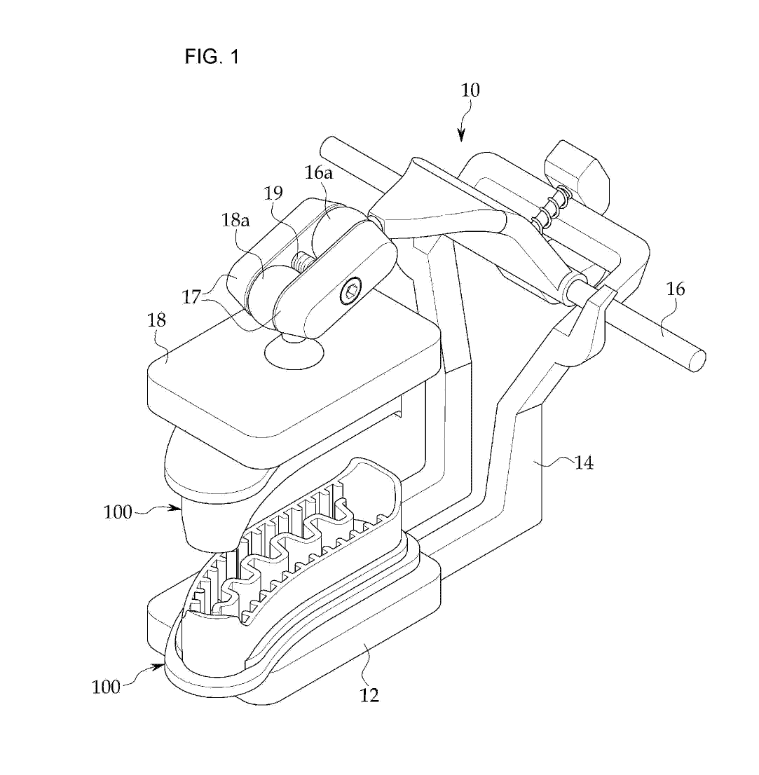

Hereinafter, an explanation on a plaster teeth model gripper and an articulator having the same according to the preferred embodiments of the present invention will be in detail given with reference to the attached drawings. While the present invention has been described with reference to the particular illustrative embodiments, it is not to be restricted by the embodiments. First, a plaster teeth model gripper 100 for use in an articulator 10 as shown in FIG. 1 will be described.

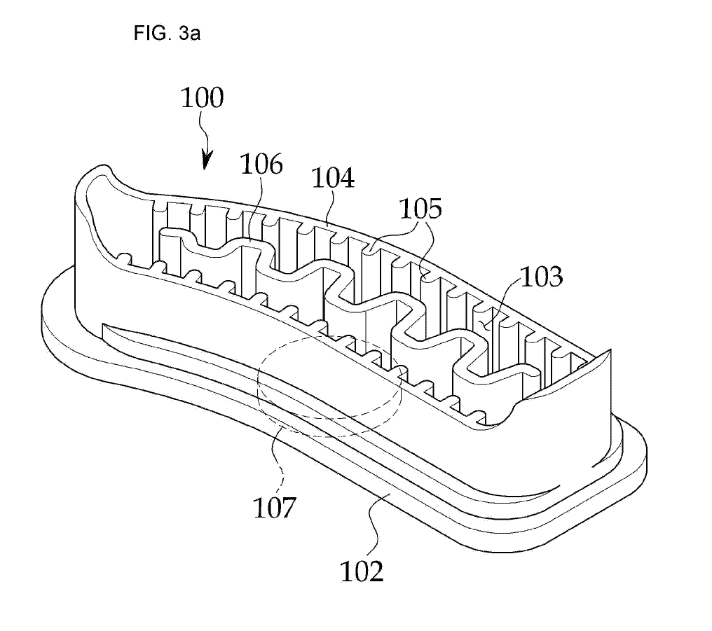

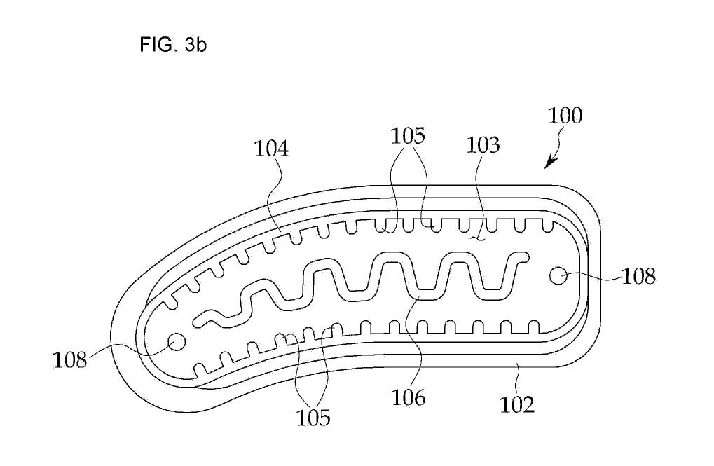

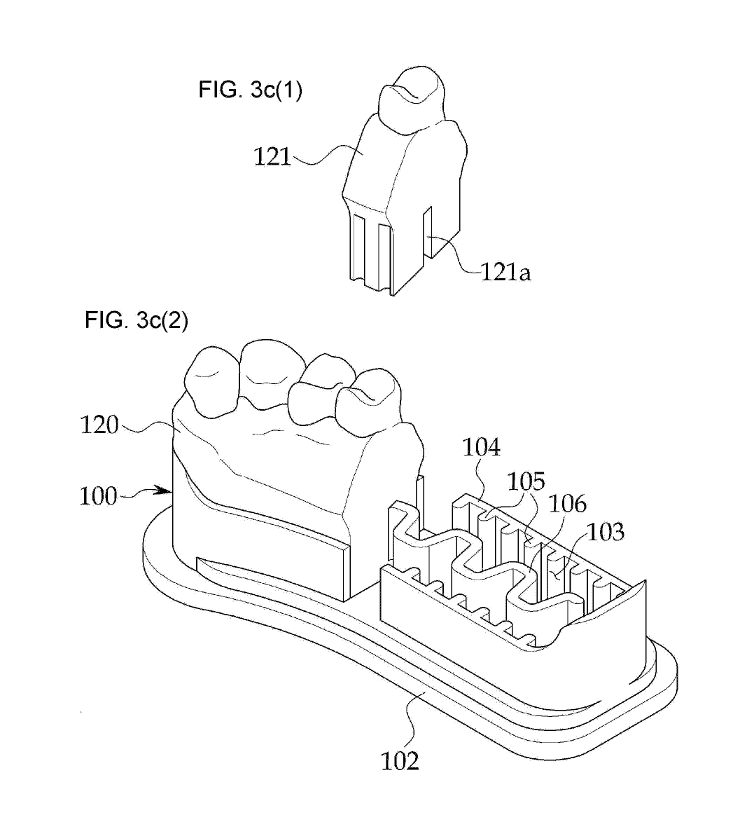

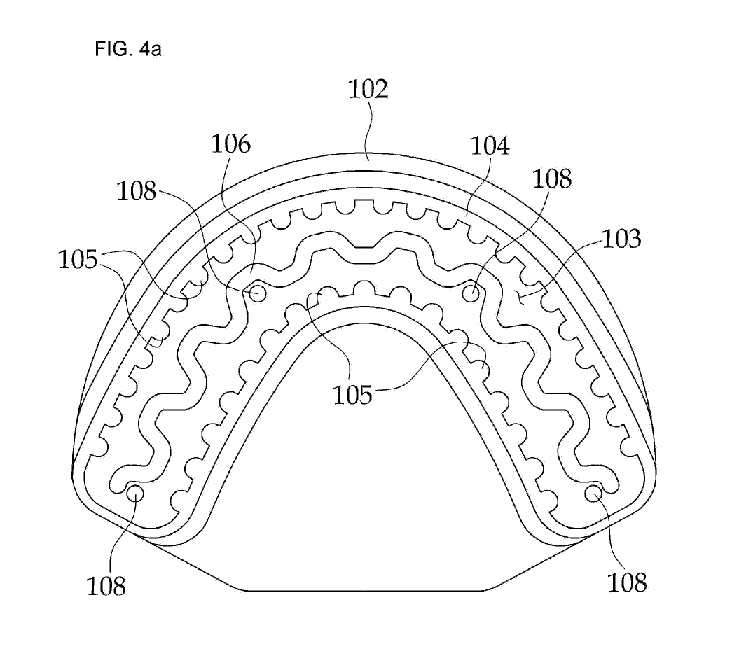

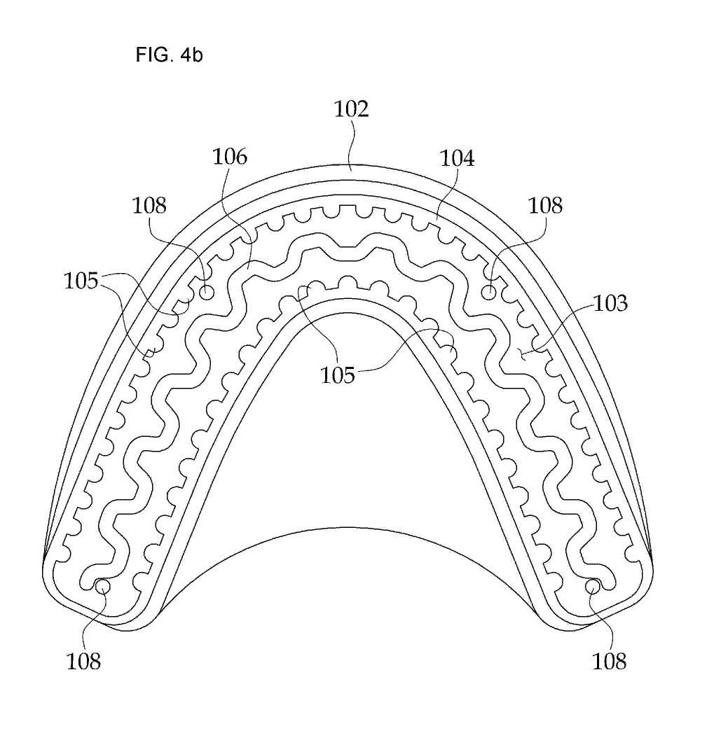

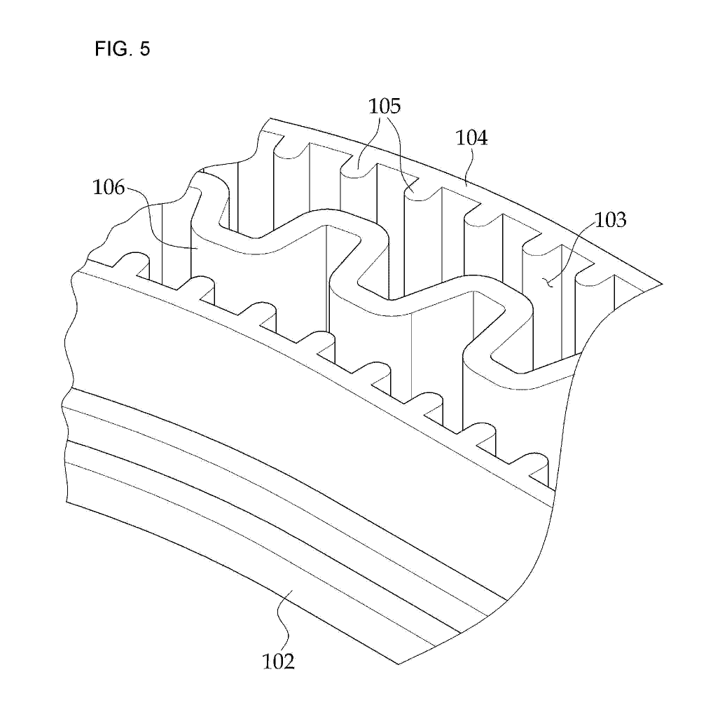

The plaster teeth model gripper 100 can be made to have three shapes in accordance with the sizes of the teeth model. The plaster teeth model gripper 100 has a shape of a partial teeth model, as shown in FIGS. 3a to 3c, and it has shapes of medium and large-sized teeth models, as shown in FIGS. 4a and 4b. Since the three shapes of the plaster teeth model gripper 100 have the same components as each other except that their sizes are different from each other and their base plates 102 have different shapes from each other, a structure of the plaster teeth model gripper 100 made for the partial teeth model in the preferred embodiment of the present invention will be described.

As shown in FIGS. 3a to 3c, the plaster teeth model gripper 100 for making the partial teeth model has a base plate 102 disposed in a flat form and a teeth model gum-supporting frame 104 formed erectedly on one surface of the base plate 102 along the outer periphery of the gum of the teeth model in such a manner as to form a teeth model gum chamber 103 open in a vertical direction from the base plate 102 at the inside thereof. The plaster teeth model gripper 100 is made of a plastic material, but it is made of metal or other materials, without any limitation thereto. So as to easily cut a required portion of the teeth model, however, it is desirably made of a plastic material. The teeth model gum-supporting frame 104 has a shape corresponding to the outer periphery of a partial or full mouth.

As shown in FIGS. 3a to 3c, the teeth model gum-supporting frame 104 has a plurality of equally spaced-apart protrusions 15 formed in the height direction along the inner periphery thereof. Desirably, the plurality of equally spaced-apart protrusions 105 has a given inclination in such a manner as to become gradually increased in sectional areas in the height direction. As a result, after an individual tooth 121 (or partial teeth) of a plaster teeth model 120 molded in the plaster teeth model gripper 100 has (have) been cut and removed, when it is fixedly inserted into its position, the insertion fitting is more ensured.

Further, the teeth model gum chamber 103 has a base protrusion 106 formed from the bottom surface of the base plate 102 at the inside thereof. Desirably, the base protrusion 106 has a shape of a continuously bent plate. The base protrusion 106 has a height equal to the teeth model gum-supporting frame 104 or a height higher or lower than the teeth model gum-supporting frame 104. At this time, desirably, the base protrusion 106 has a given pattern wherein the bending is carried out regularly therealong. The base protrusion 106 is formed of an approximately S-shaped continuous bent plate, but it is not limited thereto. The base protrusion 106 has both ends not connected to the teeth model gum-supporting frame 104, but of course, the both ends may be connected continuously thereto. Therefore, the base protrusion 106 is planted into the center portion of the root portion of the gum of the plaster teeth model 120 inserted into the teeth model gum chamber 103, thereby serving to more stably mount the plaster teeth model 120 on the teeth model gum chamber 103.

According to the present invention, the base plate 102 has a circular steel plate 107 attached on the underside thereof.

The plaster teeth model 120 is fixedly inserted into the teeth model gum chamber 103. The plaster teeth model 120 has a partial or full mouth model in accordance with the shapes of the teeth model gum-supporting frame 104. Also, the teeth model gum chamber 103 has a plurality of total or partial teeth model-detaching holes 108 formed at the ends of both sides thereof, so as to allow the overall teeth model to be separated from the plaster teeth model gripper 100.

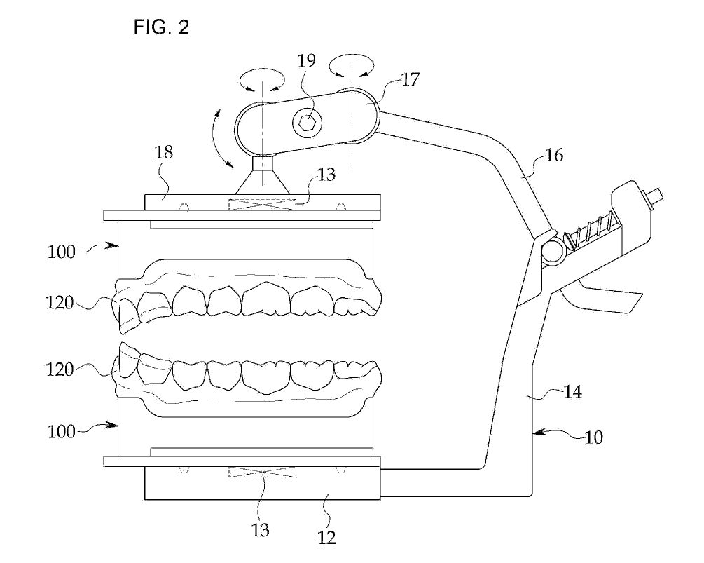

As shown in FIG. 2, the plaster teeth model 120 is mounted on the plaster teeth model gripper 100 under the above-mentioned structure.

At this time, the root portion of the lower side of the gum of the plaster teeth model 120 is insertedly fixed into the teeth model gum chamber 103. If there is a need for separation of a tooth 121 from the plaster teeth model 120, the tooth 121 is cut from the plaster teeth model 120, as shown in FIG. 3c and is a little moved to lift upwardly, thereby being easily separated therefrom. At this time, the cutting depth is somewhat lowered from the top surface of the base plate 102.

Accordingly, the hidden portion between the adjacent teeth to each other can be elaborately trimmed. After trimming, the tooth 121 is inserted fixed to its position again, and articulation is carried out. At this time, the separated tooth 121 is insertedly fixed to its position by means of the base protrusion 106. This is possible by grooves 121 a formed on the bottom surface of the tooth 121 by means of the base protrusion 106 and the plurality of equally spaced-apart protrusions 105 formed on the portion corresponding thereto when the cut tooth 121 is removed.

The plaster teeth model gripper 100 made in the above-mentioned process is applied to the articulator 10 as shown in FIGS. 1 and 2, so as to conduct the articulation.

That is, there is provided the articulator 10 having a lower plate 12 on which a lower side teeth model is mounted, an arm 16 having one end rotatably disposed at a column 14 erected from one side of the lower plate 12, and an upper plate 18 on which an upper side teeth model is mounted in such a manner as to be supported on the other end of the arm 16, wherein the plaster teeth model gripper 100 is mounted on the upper plate 18 and the lower plate 18, respectively.

Further, the articulator 10 has a magnet 13 disposed on the underside of the upper plate 18 and the top of the lower plate 12, respectively, so as to attach the plaster teeth model gripper 100 thereto through a magnetic force generated therefrom.

So as to fix the articulation posture, at this time, the upper plate 18 and the arm 16 have balls 18a and 16a mounted on the top surface thereof and the end portion thereof, and the balls 18a and 16a are connected to each other by means of a pair of ball clamps 17 fastened through a clamp bolt 19.

The clamp bolt 19 has left-handed and right-handed screws at both sides around the center of the ball clamps 17. Thus, one side left-handed screw of the clamp bolt 19 is screw-coupled to one side ball clamp 17, and the other side right-handed screw thereof is screw-coupled to the other side ball clamp 17. The pair of ball clamps 17 has spherical recesses formed on both side surfaces facing each other in such a manner as to be spherically coupled with the balls 18a and 16a.

If the fastening force of the clamp bolt 19 is released, accordingly, the upper plate 18 is freely rotated and moved in the space in every direction. After the upper plate 18 is moved to a desired position, the clamp bolt 19 is fastened, so that the ball clamps 17 pull each other to allow the upper plate 18 to be rigidly fixed to the arm 16 side.

As described above, according to the present invention, the plaster teeth model gripper is mounted on the articulator through the magnetic force of the magnet of the articulator, thereby making the plaster bonding process in the conventional practices avoided.

Further, just through the pouring of the plaster into the plaster teeth model gripper, the teeth model can be fixed well, thereby making the manufacturing process of the teeth model desirably simple.

Additionally, so as to separate only partial teeth from the teeth model in the conventional practices, separate metal pins are fixed to the teeth to be separated, and a double layered plaster die should be made, which needs complicated work and causes the unnecessary consumption of time, material and environmental aspects. Contrarily, the plaster teeth model gripper according to the present invention can perform the separation work from the teeth model in easy and accurate manners, while avoiding some of the above-mentioned processes.

In the preferred embodiments of the present invention, on the other hand, one base protrusion is provided, but the base protrusion may be provided in two or more rows within the allowance space defined by the teeth model gum chamber, while having the same shape as each other.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A plaster teeth model gripper comprising:
a base plate disposed in a flat form so as to be adapted to the underside of a gum of a teeth model; and
a teeth model gum-supporting frame formed erectly on one surface of the base plate and around the base plate so as to be adapted to follow an outer periphery of the gum of the teeth model in such a manner as to form a teeth model gum chamber open in a vertical direction from the base plate at an inside thereof,
wherein the teeth model gum chamber has a base protrusion formed from a bottom surface of the base plate at the inside thereof and a plurality of teeth model-detaching holes formed thereof,
wherein the base protrusion has a shape of alternatingly bent plate.

2. The plaster teeth model gripper according to claim 1, wherein the teeth model gum-supporting frame has a plurality of equally spaced-apart protrusions formed in a height direction along the inner periphery thereof.

3-5. (canceled)

6. The plaster teeth model gripper according to claim 1, wherein the base plate has a circular steel plate attached on a underside thereof.

7. The plaster teeth model gripper according to claim 1, wherein the teeth model gum-supporting frame has a shape of a partial or full mouth.

8. The plaster teeth model gripper according to claim 1, wherein a plaster teeth model is mounted in the teeth model gum chamber.

9. An articulator having a lower plate adapted to mount a lower side teeth model, an arm having one end rotatably disposed at a column erected from one side of the lower plate, and an upper plate adapted to mount an upper side teeth model in such a manner as to be supported on the other end of the arm, wherein a plaster teeth model gripper is mounted on the upper plate and the lower plate, respectively, the plaster teeth model gripper having a base pate disposed in a flat form so as to be adapted to a underside of a gum of a teeth model; and a teeth model gum-supporting frame formed erectly on one surface of the base plate and around the base plate so as to be adapted to follow the outer periphery of the gum of the teeth model in such a manner as to form a teeth model gum chamber open in a vertical direction from the base plate at an inside thereof, wherein the base protrusion has a shape of alternatingly bent plate.

10. The articulator according to claim 9, wherein the upper plate and the arm have balls mounted on a top surface thereof and an end portion thereof, and the balls are connected to each other through a the spherical coupling with a pair of ball clamps by means of a clamp bolt having left-handed and right-handed screws provided around a center of the ball clamps so as to fasten the pair of ball clamps facing each other.

11. The articulator according to claim 9, further comprising a magnet disposed on an underside of the upper plate and a top of the lower plate, respectively, so as to attach the plaster teeth model gripper thereto through a magnetic force generated therefrom.
